(19) United States
(12) Patent Application Publication
(10) Pub. No.: US 2016/0071222 A1
(43) Pub. Date: Mar. 10, 2016

(54) System and methods for managing relationships in a business network

(71) Applicant: GRANT PATRICK HENDERSON, ANAHEIM, CA (US)

(72) Inventor: GRANT PATRICK HENDERSON, LAS VEGAS, NV (US)

(73) Assignee: GRANT PATRICK HENDERSON, ANAHEIM, CA (US)

(21) Appl. No.: 14/845,051

(22) Filed: Sep. 3, 2015

Related U.S. Application Data
(60) Provisional application No. 62/047,236, filed on Sep. 8, 2014.

(51) Int. Cl. G06Q 50/00; H04L 12/58

(52) U.S. Cl. CPC G06Q 50/01; H04L 51/32

(57) ABSTRACT

A system and methods for managing relationships between business entities and the entities that represent them in a business network.

### CROSS-REFERENCE TO RELATED APPLICATIONS

Provisional application No. 62/047,236, filed on Sep. 8, 2014.

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISK APPENDIX

Not Applicable

### CLAIM OF PRIORITY

This patent application claims the benefit of priority, under 35 U.S.C. Section 119(e), to U.S. Provisional Patent Application Ser. No. 62/047,236, entitled “System and methods for managing relationships in a business network,” filed on Sep. 8, 2014 to Henderson, which is hereby incorporated by reference herein in its entirety.

### TECHNICAL FIELD

This invention relates to the fields of business management, information science and generally to a database of records compiled from entities with mutual common links and methods that transform these records.

### BACKGROUND OF THE INVENTION

A Person entity (“person” or plural “people”) is generally considered a legal entity with a physical embodiment.

A Business entity (“business” or plural “businesses”) is generally considered a legal entity having no physical embodiment that may be represented by one or more Person entities (including, but not limited to, employees, officers, and/or agents), Business entities, and/or other legal entities. A Business entity may use alternate names such as, company, corporation, trust, partnership, co-operative, association, etc.

A Person, although usually self-represented, may be represented by one or more other entities (e.g., via power of attorney).

A Representative is any entity, especially a Person entity that represents a Business.

Representation by a Representative of a Business must be clear in order to avoid misrepresentation of the Business by the Representative.

Action and/or communication by a Person may not legally bind the Business unless clear and accurate disclosure is made by the Person that the Person has valid authority to represent a Business, then that Person's action and/or communication may legally bind that Business.

A social network (or professional network) is a model that describes a relationship between People (e.g., Facebook™, LinkedIn™).

An enterprise social network (or business social network) is a model that describes a relationship between People within a Business (including, but not limited to, employees, officers, and agents) or, to a limited extent, external People invited to participate in the social network (e.g., Yammer™).

A business network is a model that describes a relationship between two or more Businesses and Representatives of each Business.

A Social network and a business network are distinguished from one another by the entities represented in the network. Social networks comprise People representing themselves. Business networks comprise Businesses that may be represented by Representatives, who generally use the network to interact with other businesses and the representatives of those businesses.

Social networks have attempted to include Businesses in social networks, however, those attempts have generally been limited to directory pages (e.g. Facebook™ Pages, LinkedIn™ Company Pages). Businesses have no ownership of, and/or very limited control of, the page(s) and or the subscribers to the page(s). When a Representative no longer represents the Business, the Business often has no further access to the information created by the Representative.

Social networks have focused on openness between members of a network. However, there are many situations, especially in business, where openness is not appropriate and may potentially harm the business and/or its members (e.g., confidential patient information held by a medical clinic).

What is needed is a method for Businesses to own and manage their own relationships with other Businesses and the People who represent those Businesses, thereby ensuring each Business has immediate access to all information provided by each Representative on their behalf, especially when interacting with other Businesses.

### SUMMARY OF THE INVENTION

The present invention teaches a computerized system and methods for a business network that manages relationships between business entities and the entities that represent them.

The system comprises:

a central database system that stores information about each entity and the relationships between entities;

methods for storing and transforming information that involve entity relationships;

computer servers (including server farms, and other scalable server technologies) and physical network connections (including but not limited to ethernet, wi-fi, and other electronic data networks) that facilitate electronic communication from the business networking system to any remote terminal (including but not limited to computer, mobile device, tablet, and other input/output devices).

### BRIEF DESCRIPTION OF THE DRAWINGS

FIG. 1 illustrates a computer system architecture, including the business networking system, its servers, database, methods, a computer network by which communication will occur, and the remote terminal of a Person or Representative.

FIG. 2 illustrates a computerized method for authentication and identification of a Business Representative.

FIG. 3 illustrates a representation of a set of People that represent a Business as its Representatives.

FIG. 4 illustrates a representation of a Partner Network presented to a Representative.

FIG. 5 illustrates a representation of a Trade Network presented to a Representative.

FIG. 6 illustrates a representation of a Loyalty Network presented to a Representative.

FIG. 7 illustrates a computerized method for creating a Partner Network.

FIG. 8 illustrates a computerized method for inviting other businesses to join a Partner Network.

FIG. 9 illustrates a computerized method for inviting other businesses to join a Partner Network with verification.

FIG. 10 illustrates a computerized method for allowing other businesses to request permission to join a Partner Network.

FIG. 11 illustrates a computerized method for creating a Trade Network.

FIG. 12 illustrates a computerized method for inviting other businesses to join a Trade Network.

FIG. 13 illustrates a computerized method for inviting other businesses to join a Trade Network with verification.

FIG. 14 illustrates a computerized method for allowing other businesses to request permission to join a Trade Network.

FIG. 15 illustrates a computerized method for creating a Loyalty Network.

FIG. 16 illustrates a computerized method for adding members to a Loyalty Network.

FIG. 17 illustrates a computerized method for members to add themselves to a Loyalty Network.

FIG. 18 illustrates an entity relationship diagram of People, Businesses and Representatives.

FIG. 19 illustrates an entity relationship diagram of Networks, Members, Network Members, Invitations and Requests.

### DETAILED DESCRIPTION OF THE INVENTION

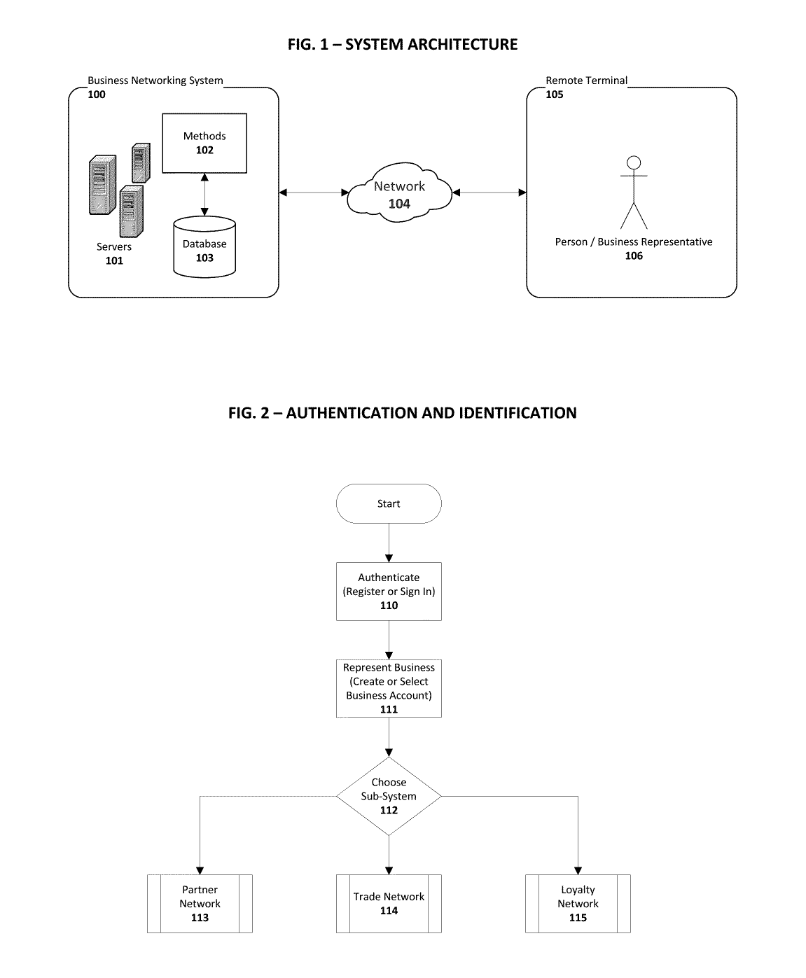

A block diagram of the computerized business networking system architecture is illustrated in FIG. 1.

The business networking system 100 comprises

a database system 103 that stores information about each entity and about the relationships between entities;

methods 102 for storing and manipulating information involving entity relationships;

computer servers 101 (including server farms, distributed computers, and/or other scalable server technologies) and physical network connections 104 (including ethernet, wifi, and/or other electronic data networks) that facilitate electronic communication from the business networking system 100 to any Remote Terminal 105 (including, but not limited to, personal computers, server computers, mobile devices, tablets, and/or other input/output devices).

The methods 102 are executed by one or more data processors and processor memory within the computer servers 101 of the business networking system 100 that manipulate data stored in the database system 103 according to the rules of the method.

The methods 102 of the business networking system 100 are accessed and initiated via HyperText Markup Language (HTML), application programming interfaces (API), and/or other network and communications technologies at a Remote Terminal 105.

The business networking methods compromise:

### Authentication and Identification

A method for authentication and identification is illustrated in FIG. 2.

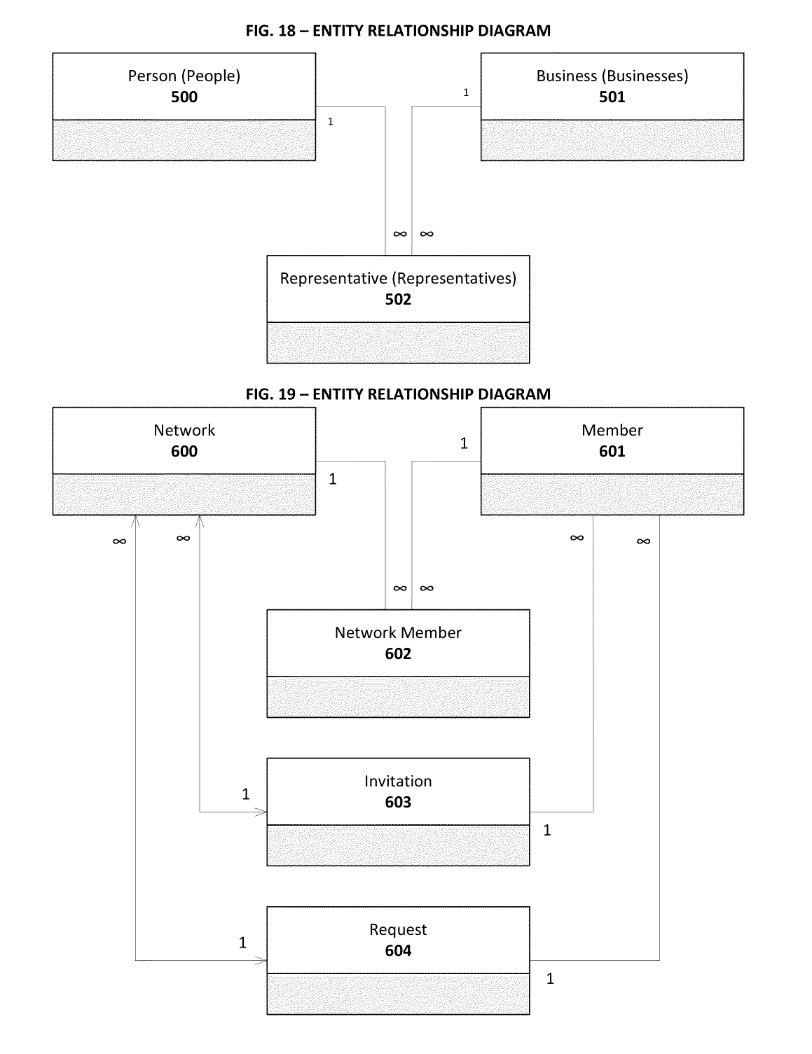

A Person entity 106 (“person”, “user” or plural “people”, “users”) authenticates 110 with the business networking system 100 by providing a unique identifier (including email, username, account number, and/or other unique identifiers) and authorization key (including password, PIN, and/or other private keys), and agrees to abide by any required terms and conditions regarding use of the system. These personal identifiers are stored in a Person database record FIG. 18 500.

A Person asserts that they represent a Business entity (“business” or plural “businesses”) 111, registers with the business networking system as a Representative of the Business, and agrees to abide by the terms and conditions of use on behalf of the Business. The Business has legal ownership of the business account and is legally bound by the agreement of its Representative. If no Business database record exists, a Business database record FIG. 18 501 is added. A Representative database record FIG. 18 502 is added with an association to the Person and Business to describe the assertion.

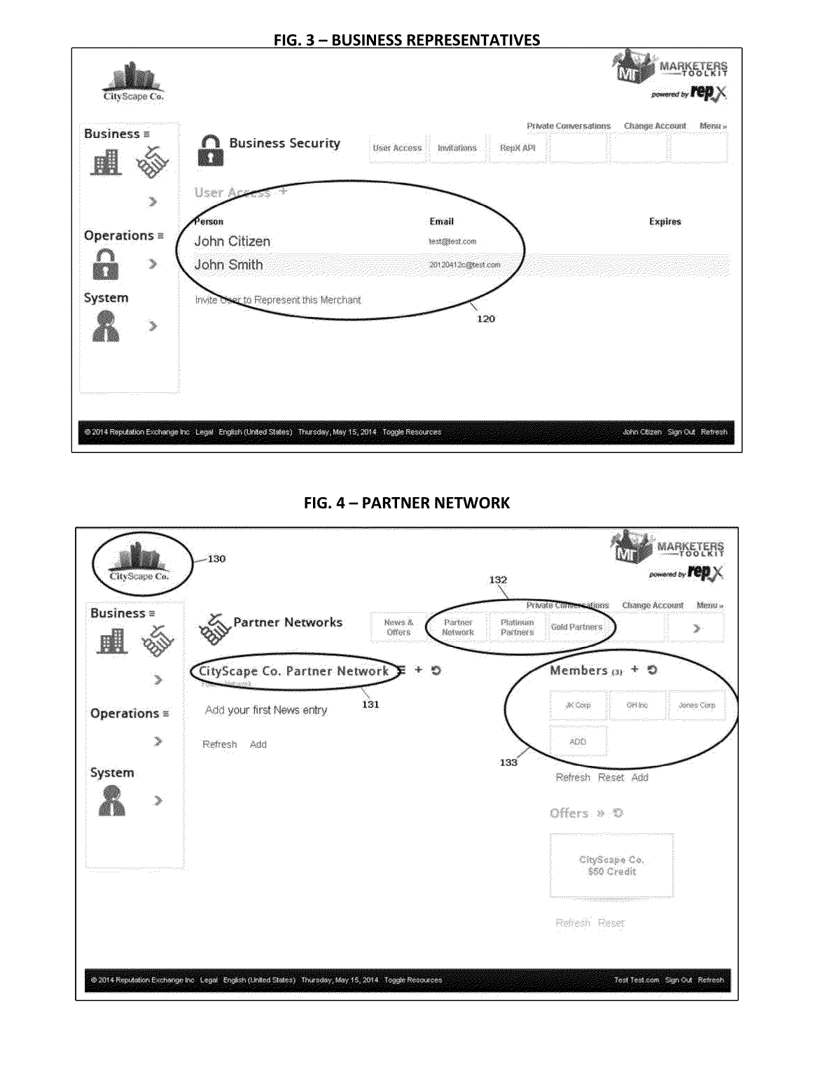

FIG. 3 illustrates a plurality of Representatives for a Business 120. A Representative may invite other People to join a Business as authorized Representatives of that Business. Each such invited Person must then authenticate 110 as a Person to the business networking system 100 and agree, for both the Business they represent and for that Person individually, to abide by the required terms and conditions.

### Business Networking Sub-Systems

After Authentication and Identification 110, a business networking sub-system is selected 112 by the user.

The Business Network is divided into three distinct types of networks: Partner Networks 113, Trade Networks 114 and Loyalty Networks 115. Each type of network has a distinct method and purpose.

### Partner Network

The purpose of a Partner Network is to enable a Business to manage its relationships with other Businesses (e.g., suppliers, business partners, resellers, wholesalers, distributors and other business relationships) in a private and confidential manner with respect to the owner of the Partner Network and each member. FIG. 19 illustrates the database records and relationships between entities where the Network 600 is the Partner Network, the Member 601 is a Business 501 but may optionally be a Person 500 or Representative 502, and an association between the Network and Member as a Network Member 602 where a Network and Member may be represented as one or more Network Members.

Each Partner Network Member is generally unable to see other members of that network and those relationships are closed to the general public. A Partner Network owner may optionally choose to make these relationships public as part of a directory.

FIG. 4 illustrates one possible representation of a Partner Network, including the Business that owns the Partner Network 130, a Partner Network owned by the Representative's Business and currently selected by the Representative 131, a set of other Partner Networks owned by the Business 132, and a set of members currently in the Partner Network 133.

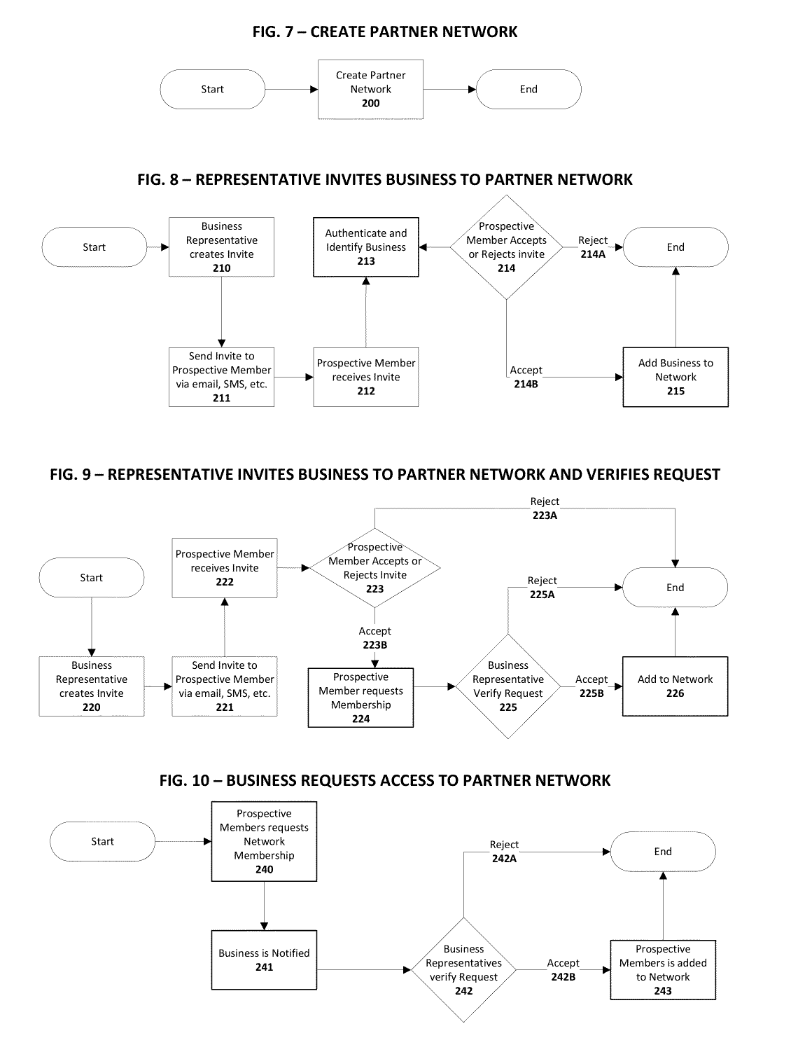

As illustrated in FIG. 7, a Representative creates one or more Partner Networks on behalf of the Business 200 that are stored as a Network 600 database records and include a Network Name, the Business that owns each Network and any number of optional fields that could be used to describe and present each Network.

As illustrated in FIG. 8, a Representative invites a potential member to join the Partner Network 210 using communication methods including, but not limited to, email, SMS, telephone, business network, or social network and the Invitation is stored in the database 603 with the associated Network, Member, a Status and any optional fields that might be used to describe the Invitation. That invitation is usually directed to a Person 211; however, the invitation may be directed to a generic contact for a Business 211 (e.g., sales email, support telephone, physical address) or a Representative of that Business. The prospective member receives the invitation 212, authenticates with the business networking system 213 & FIG. 2, reviews the invitation on behalf of a Business as its authorized Representative 214 and either Rejects the invitation 214A and the process ends or Accepts the invitation 214B, both of which update the Invitation status in the database. If Accepted 214B, that Business is added to the Partner Network 215 by the addition of Network Member 602 database record.

As illustrated in FIG. 9, the method illustrated in FIG. 8 can be further secured by including a verification mechanism. A Representative creates an Invitation 603 to a potential member 220 and sends a notification to the potential member 221 using communication methods including, but not limited to, email, SMS, telephone, business network, or social network. The potential member receives the Invitation 222 and either Rejects the invitation 223A and the process ends or Accepts the invitation 223B, both of which update the Invitation status in the database. If Accepted 223B, the potential member creates a Request 604 to join the Partner Network 224. The Request 604 includes Network, Member, Status and any optional fields that might be used to describe the Request. The original Business is then given the option to verify the request 225 and either Reject the request 225A or Accept the request 225B, both of which update the Request Status 604. If Accepted 225B, a Trade Network Member 602 database record is added 226.

As illustrated in FIG. 10, membership in the Partner Network can be openly advertised by a Representative of the owning Business. The advertisement could be a directory listing, online ad, newspaper ad, television ad, or any other form of advertisement. Upon observing the advertisement, a prospective member then requests access to the Partner Network 240 and a Request 604 database record is created. The Business is owning the Partner Network notified 241 using communication methods including, but not limited to, email, SMS, telephone, business network, or social network and one of its Representatives verifies the request 242. If Rejected 242A, the process ends. If Accepted 242B, a Network Member 602 database record is added 243.

In all methods, each Representative of each Business automatically has access to the Partner Networks to which the Business has membership to as illustrated in FIG. 18. This access may be limited to specific Representatives in instances where specific confidentiality or security is required and applied to the appropriate Representative record 502.

### Trade Network

The purpose of a Trade Network is to manage Businesses into a collective (including, but not limited to, business associations, business clubs, and chambers of commerce) in a private and confidential manner with respect to all members of the trade network. FIG. 19 illustrates the database records and relationships between entities where the Network 600 is the Trade Network, the Member 601 is a Business 501 but may optionally be a Person 500 or Representative 502, and an association between the Network and Member as a Network Member 602 where a Network and Member may be represented as one or more Network Members.

Each trade network member may see all other members of that network, but those relationships are usually closed to the general public. A Trade Network owner may optionally choose to make these relationships public as part of a directory.

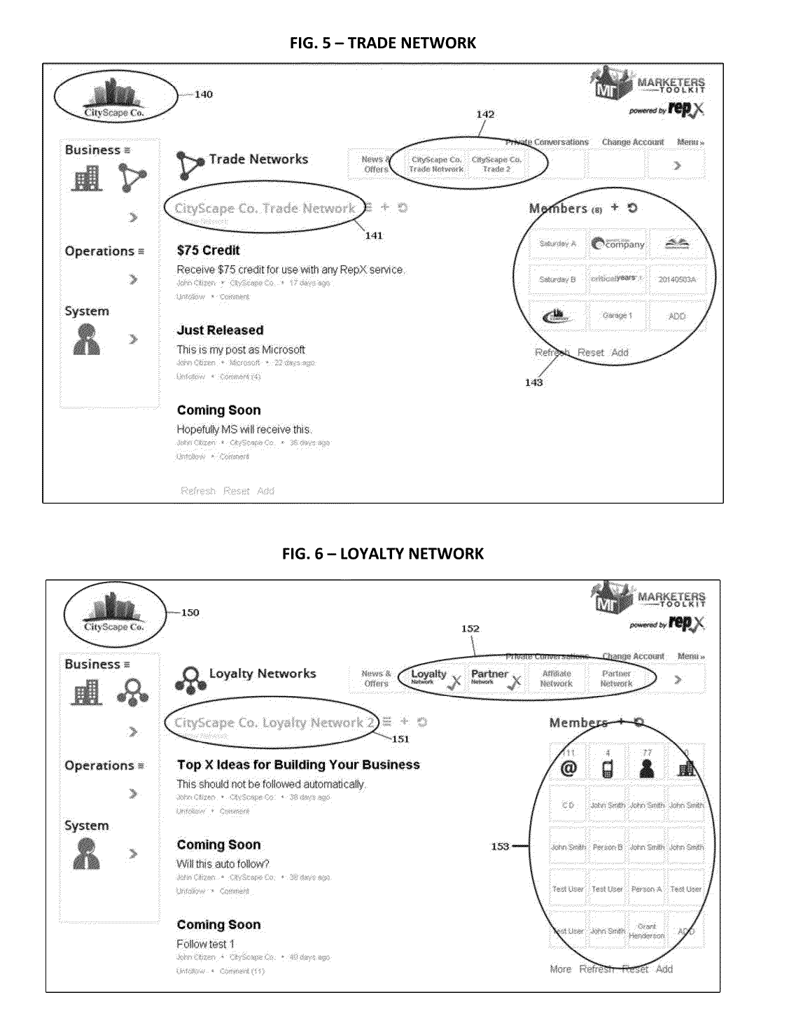

FIG. 5 illustrates one possible representation of a Trade Network, including the Business that owns the Trade Network 140, a Trade Network currently selected by the Representative 141, a set of other Trade Networks that the Business owns 142, and a set of members currently in the Trade Network 143.

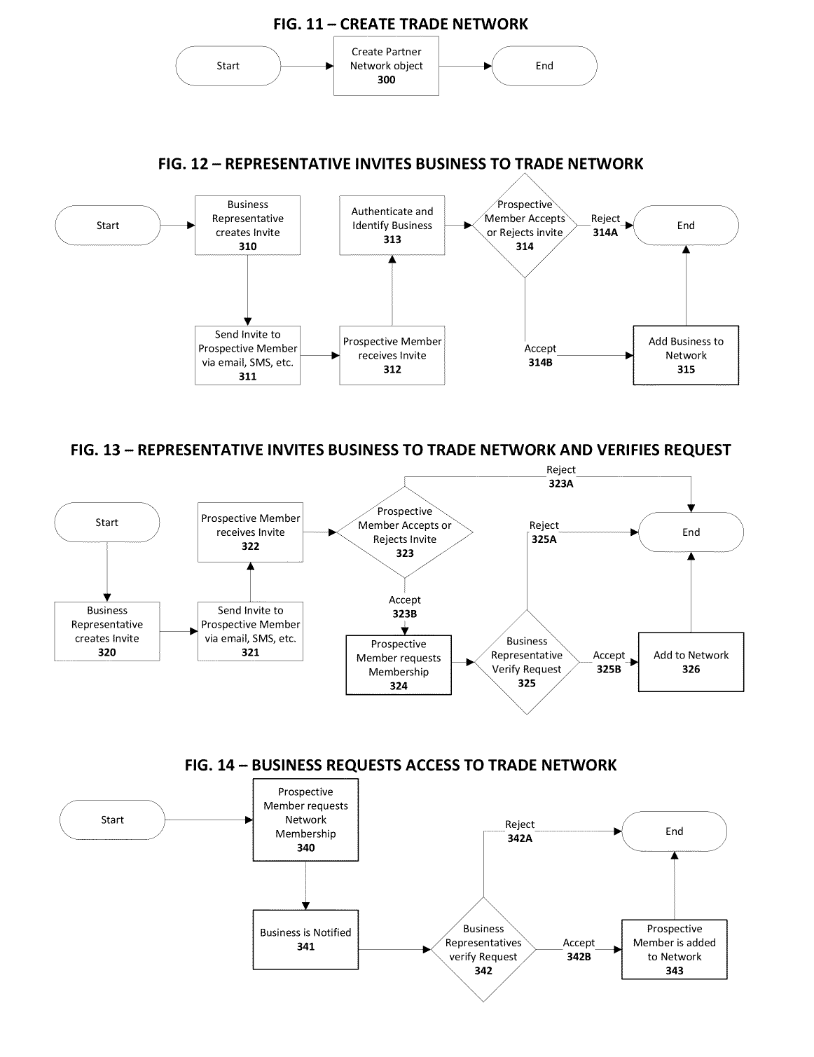

As illustrated in FIG. 11, a Representative creates one or more Trade Networks on behalf of a Business 300 that are stored as a Network 600 database records and include a Network Name, the Business that owns each Network and any number of optional fields that could be used to describe and present each Network.

As illustrated in FIG. 12, any Representative of any member Business invites a potential member to join the Trade Network 310 using communication methods including, but not limited to, email, SMS, telephone, business network, or social network and the Invitation is stored in the database 603 with the associated Network, Member, a Status and any optional fields that might be used to describe the Invitation. That invitation is generally directed to a Person; however, it may be directed to a generic contact for a Business 311 (e.g., sales email, support telephone, physical address). The invitee receives the invitation 312, authenticates with the business networking system 313 & FIG. 2, accepts the invitation on behalf of a Business as its authorized Representative 314 and either Rejects the invitation 314A and the process ends or Accepts the invitation 314B, both of which update the Invitation status in the database. If Accepted 314B, that Business is added to the Trade Network 315 by the addition of Network Member 602 database record.

As illustrated in FIG. 13, the method illustrated in FIG. 12 may be further secured by including a verification mechanism. A Representative of any member Business creates an Invitation 603 to a potential member 320 and sends a notification to the potential member 321 using communication methods including, but not limited to, email, SMS, telephone, business network, or social network. The potential member receives and reviews the Invitation 322 and either Rejects the invitation 323A and the process ends or Accepts the invitation 323B, both of which update the Invitation status in the database. If Accepted 323B, the potential member creates a Request 604 to join the Trade Network 324. The Request 604 includes Network, Member, Status and any optional fields that might be used to describe the Request. The original Business is then given the option to verify the request 325 and either Reject the request 325A and the process ends or Accept the request 325B, both of which update the Request Status 604. If Accepted 325B, a Trade Network Member 602 database record is added 326.

As illustrated in FIG. 14, membership in the Trade Network is openly advertised by a Representative of the owning business. An advertisement may be a directory listing, online ad, newspaper ad, television ad, or any other form of advertising. Upon observing the advertisement, a prospective member then requests access to the Partner Network 340 and a Request 604 database record is created. The Business owning the Trade Network is notified 341 using communication methods including, but not limited to, email, SMS, telephone, business network, or social network and one of its Representatives verifies the request 342. If Rejected 342A, the process ends. If Accepted 342B, a Network Member 602 database record is added 343.

In all embodiments, each Representative of each Business automatically has access to the Trade Networks that the Business has membership to as illustrated in FIG. 18. This access may be limited to specific Representatives in instances where specific confidentiality or security is required and applied to the appropriate Representative record 502.

Permission to invite FIG. 12 310 & FIG. 13 320 may be restricted to the Representatives of the owning Business. Similarly, permission to accept requests FIG. 13 325 & FIG. 14 342 may be restricted to the Representatives of the owning Business.

### Loyalty Network

The purpose of a Loyalty Network is to manage members (including, but not limited to, customers, investors, employees, suppliers, and business partners) in a private and confidential manner. The network is owned and managed by the Business that created the network. Optionally (and/or as required by law), members may manage their respective relationships with the network. Network members are unable to see other members of that network unless the network owner expressly permits it.

FIG. 19 illustrates the database records and relationships between entities where the Network 600 is the Loyalty Network, the Member 601 is a Business 501 but may optionally be a Person 500, Representative 502, Email Address, phone number or any other unique identifier, and an association between the Network and Member as a Network Member 602 where a Network and Member may be represented as one or more Network Members.

FIG. 6 illustrates one possible representation of a Loyalty Network, including the Business 150, a Loyalty Network owned by the Representative's Business and currently selected by the Representative 151, a set of other Loyalty Networks owned by the Business 152, and a set of members currently in the Loyalty Network 153 represented by email addresses or phone numbers.

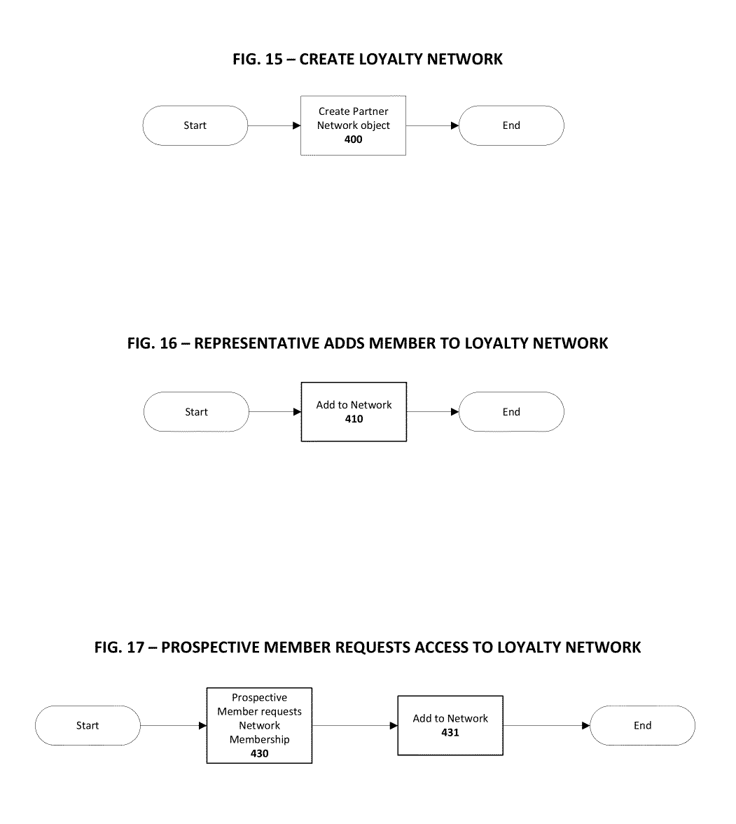

As illustrated in FIG. 15, a Representative creates one or more Loyalty Networks on behalf of a Business 400 that are stored as a Network 600 database records and include a Network Name, the Business that owns each Network and any number of optional fields that could be used to describe and present each Network.

As illustrated in FIG. 16, a Representative adds member information (e.g., name, address, email, telephone) to the Loyalty Network 410. The member is immediately added as a member of the network and is not required to give consent although optional consent may be requested.

As illustrated in FIG. 17, membership in the Loyalty Network is openly advertised by a Representative of the owning Business. An advertisement may be a directory listing, online ad, newspaper ad, television ad, or any other form of advertising. A prospective member observes the advertisement and requests access to the Loyalty Network 430. A Network Member 602 database record is immediately added to the database 431 and linked to the Loyalty Network 601. The owning Business may be optionally notified of the addition. A Request Authorization process may also be implemented in the same manner as Partner Networks FIG. 9 and Trade Networks FIG. 13 to restrict membership to the Network.

### Clarification of differences between Partner, Trade, Loyalty and Social Networks

To clarify the differences between, and the varying effects of, the business networking 100 sub-systems versus a social network, the following comparison is included:

Social Networks comprise memberships of People with a valid identifier (e.g., email, telephone). Relationships are formed between two or more People. Members can see each other.

Partner Networks FIG. 2 113 and FIG. 4 comprise a Network and memberships of Businesses and their Representatives. Relationships are formed between the network owner and one or more Businesses. Members cannot see each other. A Business may own multiple Partner Networks, each separate from each other Network.

Trade Networks FIG. 2 114 and FIG. 5 comprise a Network and memberships of Businesses and their Representatives. Relationships are formed between two or more Businesses. Members can see each other. A Business may own multiple Trade Networks, each separate from each other Network.

Loyalty Networks FIG. 2 115 and FIG. 6 comprise a Network and memberships of valid contacts (e.g., email, telephone). Relationships are formed between the network owner and each member. Members cannot see each other. A Business may own multiple Loyalty Networks, each separate from each other Network.

### Variations

A Business does not strictly have to be a legal entity. A Business could be any grouping of people where the group itself may be treated as a Business and is included in each Business Network.

Although the present invention has been described in terms of various embodiments, it is not intended that the invention be limited to these embodiments. Modification within the spirit of the invention will be apparent to those skilled in the art.

I claim:

1. A method for business networking comprising:
creating a plurality of representative entities that track relationships between business entities and people entities;
creating at least one network entity;
creating at least one network member entity that references at least one network entity, and references at least one business entity or references at least one representative entity or references at least one person entity;
recording entities and relationships between entities in a computer;
identifying a business by a person;
determining by said person that said person is a representative of said business; and
verifying that said person is a representative of said business;
whereby, one or more business networks of businesses and representatives is created.

2. A method according to claim 1 further comprising:
inviting at least one business or at least one representative to join said network by at least business that manages said network or by at least one representative that manages said network; and
accepting said invitation by an invited business or an invited representative.

3. A method according to claim 2 further comprising:
verifying that said invited business or said invited representative is permitted to join said network by at least one business that manages said network or by at least one representative that manages said network.

4. A method according to claim 1 further comprising:
inviting at least one business or at least representative to join said network by at least one network member of said network; and
accepting said invitation by an invited business or an invited representative.

5. A method according to claim 4 further comprising:
verifying that said invited business or said invited representative is permitted to join said network by at least one business that manages said network, or at least one representative that manages said network, or by at least one network member of said network.

6. A method according to claim 1 further comprising:
requesting by a business or a representative to join said network.

7. A method according to claim 6 further comprising:
verifying said request to join said network by at least one business that manages said network, or by at least one representative that manages said network, or by at least one network member of said network.

8. A method according to claim 1 further comprising:
adding at least one business or at least one representative as network members to said network.

9. A non-transitory computer-readable medium including one or more sequences of instructions which, when executed by one or more processors, cause:
creating a plurality of representative entities that track relationships between business entities and people entities;
creating at least one network entity;
creating at least one network member entity that references at least one network entity, and references at least one business entity or references at least one representative entity or references at least one person entity;
recording entities and relationships between entities;
identifying a business by a person;
determining by said person that said person is a representative of said business; and
verifying that said person is a representative of said business;
whereby, one or more business networks of businesses and representatives is created.

10. The non-transitory computer-readable medium of claim 9, wherein the instructions cause:
inviting at least one business or at least one representative to join said network by at least business that manages said network or by at least one representative that manages said network; and
accepting said invitation by an invited business or an invited representative.

11. The non-transitory computer-readable medium of claim 10, wherein the instructions cause:
verifying that said invited business or said invited representative is permitted to join said network by at least one business that manages said network or by at least one representative that manages said network.

12. The non-transitory computer-readable medium of claim 9, wherein the instructions cause:
inviting at least one business or at least representative to join said network by at least one network member of said network; and
accepting said invitation by an invited business or an invited representative.

13. The non-transitory computer-readable medium of claim 12, wherein the instructions cause:
verifying that said invited business or said invited representative is permitted to join said network by at least one business that manages said network, or at least one representative that manages said network, or by at least one network member of said network.

14. The non-transitory computer-readable medium of claim 9, wherein the instructions cause:
requesting by a business or a representative to join said network.

15. The non-transitory computer-readable medium of claim 14, wherein the instructions cause:
verifying said request to join said network by at least one business that manages said network, or by at least one representative that manages said network, or by at least one network member of said network.

16. The non-transitory computer-readable medium of claim 9, wherein the instructions cause:
adding at least one business or at least one representative as network members to said network.

17. A system comprising:
one or more processors; and
a non-transitory computer-readable medium including one or more sequences of instructions which, when executed by one or more processors, cause:
creating a plurality of representative entities that track relationships between business entities and people entities;
creating at least one network entity;
creating at least one network member entity that references at least one network entity, and references at least one business entity or references at least one representative entity or references at least one person entity;
recording entities and relationships between entities;
identifying a business by a person;
determining by said person that said person is a representative of said business; and
verifying that said person is a representative of said business;
whereby, one or more business networks of businesses and representatives is created.

18. The system of claim 17, wherein the instructions cause:
inviting at least one business or at least one representative to join said network by at least business that manages said network or by at least one representative that manages said network; and
accepting said invitation by an invited business or an invited representative.

19. The system of claim 18, wherein the instructions cause:
verifying that said invited business or said invited representative is permitted to join said network by at least one business that manages said network or by at least one representative that manages said network.

20. The system of claim 17, wherein the instructions cause:
inviting at least one business or at least representative to join said network by at least one network member of said network; and
accepting said invitation by an invited business or an invited representative.

21. The system of claim 20, wherein the instructions cause:
verifying that said invited business or said invited representative is permitted to join said network by at least one business that manages said network, or at least one representative that manages said network, or by at least one network member of said network.

22. The system of claim 17, wherein the instructions cause:
requesting by a business or a representative to join said network.

23. The system of claim 22, wherein the instructions cause:
verifying said request to join said network by at least one business that manages said network, or by at least one representative that manages said network, or by at least one network member of said network.

24. The system of claim 17, wherein the instructions cause:
adding at least one business or at least one representative as network members to said network.
